(19) United States
(12) Patent Application Publication
(10) Pub. No.: US 2025/0296094 A1
(43) Pub. Date: Sep. 25, 2025

(54) Cyclone Separator For Separating Solids and/or Liquids From a Process Stream

(71) Applicant: ESTA APPARATEBAU GMBH & CO. KG, Senden (DE)

(72) Inventors: Michael Novosel, Nattheim (DE); Maik Herrmann, Elchingen (DE); Johann Paul Hahn, Dietenheim (DE)

(73) Assignee: ESTA APPARATEBAU GMBH & CO. KG, Senden (DE)

(21) Appl. No.: 18/857,811

(22) PCT Filed: Apr. 26, 2023
(86) PCT No.: PCT/EP2023/060897

§ 371 Date: Oct. 17, 2024

(30) Foreign Application Priority Data
Apr. 29, 2022 (DE) 10 2022 110 536.9
Apr. 29, 2022 (EP) 22170817.5

(51) Int. Cl. B04C 5/103; B04C 5/04; B04C 5/13

(52) U.S. Cl. CPC B04C 5/103; B04C 5/04; B04C 5/13

(57) ABSTRACT

The invention relates to a cyclone separator (1) for separating solids and/or liquids from a process stream, comprising a process space (3) which is formed at least by a surrounding wall (2) and a covering (5) and is round in cross section, an inlet port (4) which penetrates the surrounding wall (2) for enabling intake of the process stream into the process space (3) in the circumferential direction (U) of the process space (3), an outlet port (6) which penetrates the covering (5) for enabling the exit of the process stream from the process space (3) in the axial direction (A) of the process space (3), an immersion tube (7) which extends into the process space (3) from the outlet port (6) in the axial direction (A), and guiding means (11.1, 11.2, 11.3, 11.4) extending centrally in the process space (3) in the axial direction (A) and impinging into the immersion tube (7). According to a first aspect of the invention, the cross section of the guiding means (11.1, 11.2, 11.3, 11.4) can be varied at least in one part of its axial extent. The invention further relates to a method and to a cyclone separator system.

### TECHNICAL FIELD

The present invention relates to a cyclone separator for separating solids and/or liquids from a process stream. The present invention further relates to a method for operating such a cyclone separator and to a cyclone separator system comprising such a cyclone separator.

### BACKGROUND OF THE INVENTION

Such cyclone separators are known from the prior art and are used, for example, for separating dust from process air. For this purpose, the process stream is guided into a process space that is round in cross-section, in which it flows along a circumferential trajectory guided by a circumferential wall, so that solids and/or liquids are carried radially outwards by centrifugal force. The process stream is also guided axially in the process space in a first direction from an inlet to a deflection point, resulting in an overall helical trajectory. At the deflection point, the process stream is then discharged axially in the opposite direction to the first direction to an outlet port, wherein the solids and/or liquids can no longer follow the resulting deflection due to their inertia and fall out.

It is also known to provide an immersion tube at the outlet port, which projects into the process space, and to arrange a guiding means in the center of the immersion tube, which extends axially through the entire process space. The guiding means is used to guide the process stream between the deflection point and the outlet port and is usually formed as a cylindrical rod. The exact geometry of the cross-section of the guiding means, in particular the diameter in the case of a round guiding means, influences the pressure loss and the degree of separation of a cyclone separator. Disadvantageously, it is not possible to achieve ideal operating parameters of the cyclone separator for many process streams with a given cross-sectional geometry of the guiding means, in particular a lowest possible pressure loss and a highest possible degree of separation. The area of application of the cyclone separator is therefore disadvantageously limited.

### DESCRIPTION OF THE INVENTION

Based on this situation, it is an object of the present invention to enable a cyclone separator to be used in a wider area of applications with improved operating parameters.

The object of the invention is achieved by the features of the independent main claims. Advantageous embodiments are provided in the subclaims. Where technically possible, the teachings of the subclaims can be combined as desired with the teachings of the main and subclaims.

According to a first aspect of the invention, the object is achieved by a cyclone separator for separating solids and/or liquids from a process stream, comprising a process space which is formed at least by a peripheral wall and a covering and which is round in cross- section, an inlet port which penetrates the peripheral wall for introducing the process stream into the process space in the circumferential direction of the process space, an outlet port penetrating the covering for discharging the process stream out of the process space in the axial direction of the process space, an immersion tube extending from the outlet port in the axial direction into the process space, and a guiding means extending in the axial direction in the center of the process space and engaging in the immersion tube. According to the first aspect of the invention, it is provided that the guiding means is designed to be variable in cross-section over at least a part of its axial extension.

Advantages of the claimed aspects of the invention are explained below and preferred modified embodiments of the aspects of the invention are described further below.

Explanations, in particular with respect to advantages and definitions of features, are basically descriptive and preferred, but not limiting, examples. If an explanation is limiting, this is explicitly mentioned.

A cyclone separator is understood to be a device in which, by guiding a mainly gaseous process stream along a helical trajectory, a separating force is generated on solids and/or liquids contained in the process stream and a separation of the solids or liquids takes place, in particular by deflecting the process stream. A helical shape is also understood to mean, in particular, a helical shape with an outer diameter that tapers at least in certain areas. In such a cyclone separator, dust, chips or abrasion, for example from a machining process, can be separated from a gas stream such as an air or inert gas stream.

A circumferential wall is understood to mean a wall that corresponds to a geometric envelope of such a helical shape and guides the process stream along the trajectory. The circumferential wall can be formed cylindrical over axial areas and/or conical over axial areas. In particular, the circumferential wall is cylindrical in an area of the inlet port and conical in an area axially spaced therefrom. A covering is arranged at a head end of the round circumferential wall as a closure of the process space, in particular at a head end in the area of the inlet port, in which the circumferential wall is formed in a cylindrical shape.

An immersion tube is formed as a sleeve, in particular in the circumference of the outlet port, and protrudes into the process space, for example, between one fifth and half of the axial extension of the process space. Such an immersion tube brings about an efficient separation of a flow running in a first direction and a flow directed against the first direction after a deflection.

By means of a guiding means, it is achieved that a flow directed against the first direction after a deflection is guided so that turbulences and thus a flow resistance in this flow section are reduced. The guiding means and thus also the flow directed against the first direction extends in particular radially within the helical trajectory of the flow before a deflection. The guiding means extends particularly preferably in an axial direction over the entire process space and is further preferably cylindrical in shape, it may, however, also have any other cross-sectional geometry/geometries. With a guiding means, reduced pressure losses and an increased degree of separation can be achieved in a cyclone separator compared to a cyclone separator not equipped with such a guiding means.

The first aspect of the invention now includes the teaching that the guiding means is formed variable in cross-section. This is to be understood to mean that the cross-sectional area of the guiding means can be changed in size, for example, while the geometry remains the same, that the geometry itself can be changed, or that a cross-section of the guiding means can be displaced transversely to the axial direction, for example. In this way, the guiding means can be adapted to a particular process stream in such a way that the operating parameters are optimized for this process stream. For example, a most favorable relationship between a low pressure loss and a high degree of separation can be set. In this way, the cyclone separator can be used for a variety of process streams.

Furthermore, the cyclone separator according to the first aspect of the invention also makes it possible for the cross-section to be tracked during operation by a control unit or controller to a process stream which changes in at least one property. For example, the process stream can change in its speed of movement, its mass flow or its composition, in particular with regard to solid or liquid loading. The properties of the process stream are then recorded and evaluated by sensors, for example, wherein an ideal guiding means cross-section is calculated by use of data processing means and set at the guide medium by use of control means.

In one embodiment, the guiding means is designed as a guide tube. A guide tube represents an inherently simple and therefore cost-effective geometry, which can also be easily modified. In addition, a guide tube has a low mass as an internally hollow geometry.

Particularly preferable the guide tube has a round outer geometry at which a flow can form a helix in an area between the deflection point and the outlet port, or is guided in a helix form. In this way, a particularly low pressure loss can be achieved in this area.

In one embodiment, the guide tube is formed elastic and an interior of the guide tube is designed variable in volume in order to change the cross-section of the guide tube. In this case, means for inflating the inner spacer and/or means for extracting air from the inner space are provided, for example. By changing the volume of the inner space, the outer diameter of the elastic guide tube is also changed so that a desired cross-sectional geometry and/or, in particular, a desired relationship between the geometry of the guiding means and the geometry of the immersion tube is achieved by changing the volume of the inner space. In particular, by designing the guide tube with different moduli of elasticity over its axial extension, it is possible to ensure that the change in the inner space volume and thus also the cross-sectional geometry is limited or focused on certain axial sections of the guide tube, so that, for example, a change in the guide means occurs preferentially in the area of the immersion tube, or that a deformation occurs as uniformly as possible along the guide tube.

In a further embodiment, a tube wall of the guide tube is formed in a spiral shape. For example, the tube wall is formed by a spiral-shaped wire and an elastic sheathing of the wire or a spiral-shaped strip, whereby spiral windings together form a preferably closed tube wall. With a spiral-shaped tube wall, a simultaneously elastic, lightweight and inherently stable guide tube can be formed. In one embodiment, spiral windings are designed to rotate against each other, wherein the cross-sectional geometry of the guide tube can then be changed by a torsion of the guide tube. A torsion then causes a stretching or compression of the spiral-shaped guide tube.

In one embodiment of the cyclone separator, the guiding means is formed elastic and the cyclone separator comprises means for compressing and/or stretching the guiding means to change the cross-section of the guiding means. The guiding means then changes its cross-section in order to maintain its volume during stretching and/or compression and is thus either expanded or constricted. In this way, a desired cross-sectional geometry and/or, in particular, a desired relationship between the geometry of the guiding means and the geometry of the immersion tube is achieved.

In one embodiment, the guiding means comprises a plurality of at least two sections along its axial extension, wherein at least two sections having different moduli of elasticity from one another. The change in cross-section that occurs as a result of compression and/or stretching can then be limited or focused on certain axial sections of the guiding means, so that, for example, a change in the guiding means occurs preferentially in the area of the immersion tube.

In a further embodiment, the guiding means comprises several sections along its axial extension and at least two sections are designed to be displaceable relative to each other in the axial direction in order to change the cross-section of the guiding means. For example, a section with a desired cross-section is then shifted into an axial area in which the relevant cross-section is desired, in particular into the area of the immersion tube. In addition, sections can optionally be arranged outside the process space or at the guiding means inside the process space. For example, the guiding means can be provided with different rings of a certain geometry, so that different guiding means geometries result overall.

In yet another embodiment, the cyclone separator comprises means for imparting an oscillation to the guiding means in order to change the cross-section of the guiding means. By means of such an oscillation, the guiding means can be expanded and constricted in particular in sections or displaced transversely to the axial direction. In particular, at a sufficiently high frequency, it is possible to achieve that an area occupied by the oscillation acts as an effective geometry for guiding the process stream, wherein the actual cross-section of the guiding means is at least temporarily smaller than this geometry. Furthermore, an oscillation of the guiding means makes it more difficult or even completely prevents solids from adhering to a surface of the guiding means facing the process space. Solids adhering to the guide tube, and also to the circumferential wall, can disrupt the flow trajectory and lead to increased pressure losses and/or a reduced degree of separation.

In a further, preferred embodiment, the cross-section of the immersion tube is formed variable or comprises an orifice with a variable clear cross-section. The relationship between the cross-sectional geometry of the guiding means and the cross-sectional geometry of the immersion tube can then also be influenced from the side of the immersion tube and can therefore in particular be changed in a larger variance range, in particular in the course of control or regulation.

In a further, also preferred embodiment, the guiding means is made of a plastic, in particular an elastomer or a thermoplastic. Such a plastic can be used to create a sufficiently stable, lightweight and elastic guiding means. The plastic is, for example, formed as rubber, polyethylene, polypropylene or polyvinyl chloride.

In yet another embodiment, the circumferential wall is formed conical over at least a part of its axial extension. The process stream is then guided to a deflection point along a narrowing trajectory.

In one embodiment, the inlet port comprises a slot-shaped extension in the axial direction of the process space. In this way, a back pressure can be reduced compared to a non-slot-shaped geometry, for example a square geometry. In particular, the inlet port extends in the axial direction entirely over a cylindrical area of the circumferential wall, wherein a conical area of the circumferential wall extends in the axial direction immediately adjacent to the cylindrical area.

In a further embodiment, the cyclone separator comprises a solids outlet arranged at one end of the process space for discharging solids from the process space. In this way, solids and, in particular, released solids adherences can be removed from the process space. The outlet opening is designed to be closable, for example with a flap, in order to separate the process space from the environment.

A second aspect of the invention relates to a method for operating a cyclone separator as described above, wherein the cross-section of the guiding means is varied at least in a part of the axial extension of the guiding means as a function of a mass flow, a flow velocity, a solids load or a liquid load of the process stream. In this respect, the cyclone separator is operated in a controlled or regulated manner according to the aforementioned process stream properties and can therefore be set to ideal operating parameters at any time. In particular, the most favorable relationship between a low pressure loss and a high degree of separation can be set at any time. In particular, appropriate means such as sensors, data processing means, control means and/or signal transmission means are provided for carrying out the method.

A third aspect of the invention relates to a cyclone separator system comprising a cyclone separator as described above and at least one sensor for detecting a mass flow, a flow velocity, a solids load or a liquid load of the process stream. The cyclone separator system also preferably comprises data processing means, control means and/or signal transmission means for respectively controlling and/or regulating the operating parameters of the cyclone separator. Such a cyclone separator system can advantageously be used to carry out a method described above for operating a cyclone separator with the advantages mentioned in this regard.

### BRIEF DESCRIPTION OF THE DRAWINGS

In the following, the invention is explained in more detail with reference to the attached drawings based on preferred embodiments. The term figure is abbreviated as Fig. in the drawings.

In the drawings:

FIG. 1 shows a schematic sectional view of a cyclone separator according to a preferred exemplary embodiment of the first aspect of the invention;

FIG. 2 shows a cross-sectional view of the cyclone separator according to the section B-B of FIG. 1;

FIG. 3a shows a schematic sectional view of a guiding means in a first embodiment for a cyclone separator according to the first aspect of the invention;

FIG. 3b shows a further schematic sectional view of the guiding means according to FIG. 3a;

FIG. 4a shows a schematic sectional view of a guiding means in a second embodiment for a cyclone separator according to the first aspect of the invention;

FIG. 4b shows a further schematic sectional view of the guiding means according to FIG. 4a;

FIG. 5a shows a schematic sectional view of a guiding means in a third embodiment for a cyclone separator according to the first aspect of the invention; and

FIG. 5b shows a further schematic sectional view of the guiding means according to FIG. 5a;

### DETAILED DESCRIPTION OF THE EXEMPLARY EMBODIMENTS

The described exemplary embodiments are merely examples, which can be modified and/or supplemented in a variety of ways within the scope of the claims. Each feature described for a particular exemplary embodiment can be used independently or in combination with other features in any other exemplary embodiment. Each feature described for an exemplary embodiment of a particular claim category can also be used in a corresponding manner in an exemplary embodiment of another claim category.

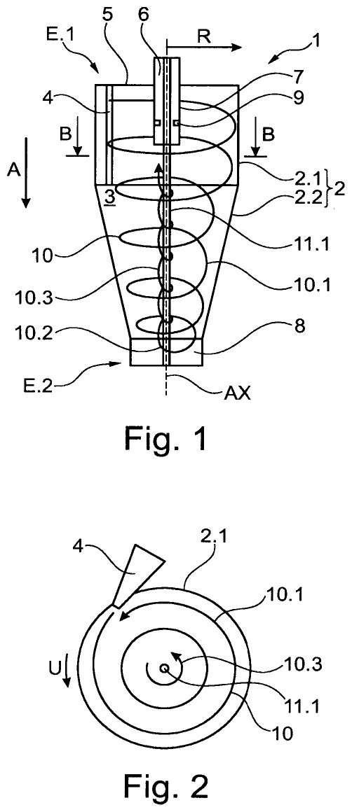

FIG. 1 shows a cyclone separator 1 in a first embodiment. The cyclone separator 1 comprises a circumferential wall 2, which is formed by a first wall section 2.1 and a second wall section 2.2 and defines a process space 3 that is centred around an axis AX and is round in cross-section. The first wall section 2.1 is formed cylindrical and is penetrated by a slot-shaped inlet port 4. Furthermore, the first wall section 2.1 is closed at a first end E.1 of the circumferential wall 2 by a covering 5. The covering 5 is penetrated by an outlet port 6, which is arranged coaxially with the axis AX and comprises an immersion tube 7, which projects from the covering 5 in an axial direction A into the process space 3. The axial direction A shown here corresponds to a previously referenced first direction. The second wall section 2.2 adjoins the first wall section 2.1 in the axial direction A and extends conically tapering to a second end E.2 of the circumferential wall 2. At the second end E.2, the second wall section 2.2 is terminated by a solids outlet 8. Furthermore, the cyclone separator 1 comprises a cylindrical guiding means 11.1. The guiding means 11.1 is designed, for example, as a guide rod or guide tube and extends coaxially to the axis AX through the entire process space 3.

In the process space 3, a helical trajectory 10 is obtained in a first area 10.1 for a process stream flowing in at the inlet port 4. The first area 10.1 extends from the inlet port 4 in axial direction A to the second end E.2 of the circumferential wall 2 and is narrowed in the outer diameter of the helix shape by the second wall section 2.2. In this case, solids and/or liquids contained in the mainly gaseous process stream are carried outwards in a radial direction R. At the second end E.2 of the circumferential wall 2, the trajectory 10 then has a deflection point 10.2, at which the process stream is deflected opposite the axial direction A and guided along a second area 10.3 to the outlet port 6 or immersion tube 7, wherein a helical trajectory continues to exist. Due to the guiding means 11.1, the process stream is also guided in its helical form in the second area 10.3 of the trajectory 10, so that the flow can form there with reduced turbulence and a reduced pressure loss can be achieved. At the deflection point 10.2, the solids and/or liquids carried to the outside can no longer follow the trajectory 10 due to their inertia and fall out.

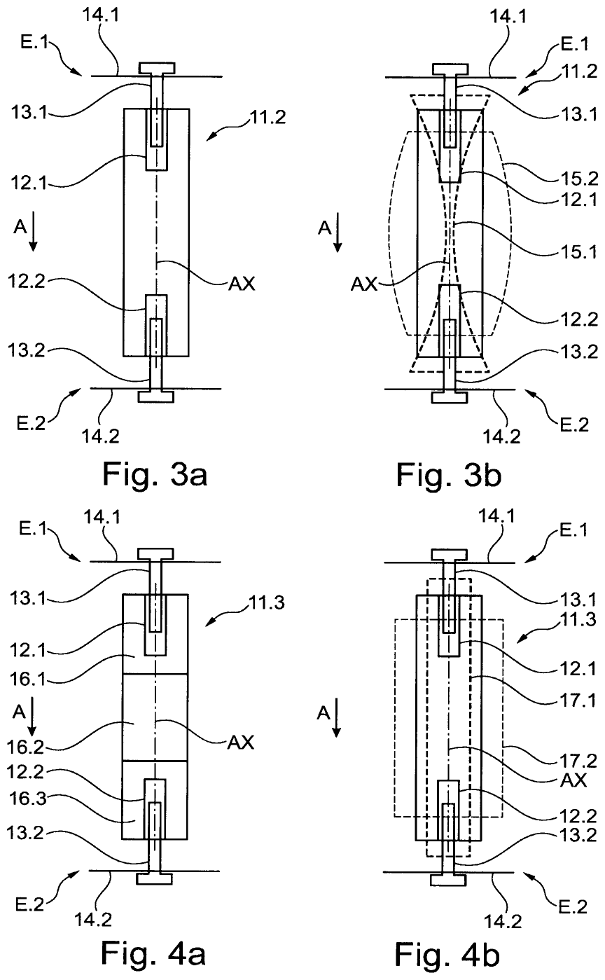

The pressure loss and the degree of separation of the cyclone separator 1 is determined, among other things, by the relationship between the cross-sectional geometry of the guide medium 11.1 and the cross-sectional geometry of the immersion tube 7. On the one hand, the cross-section of the guiding means 11.1 is formed variable, as will be explained in more detail below with respect to FIGS. 3a to 5b. On the other hand, an orifice 9 is arranged in the immersion tube 7, which is formed variable in its clear cross-section and via which, in addition to a guiding means 11.1 variable in its cross-section, the aforementioned relationship can be influenced in order to achieve an optimum compromise between low pressure loss and high degree of separation for certain properties of a process stream. The orifice 9 is designed as an iris diaphragm, for example.

FIG. 2 shows a cross-section from FIG. 1 according to section B-B. It can be seen that the circumferential wall 2 is formed round in cross-section and guides the first area 10.1 of the trajectory 10 in a helical shape. In the second area 10.3 of the trajectory 10, it is also formed helical along the guiding means 11.1. Furthermore, an alignment of the inlet port 4 in a circumferential direction U is shown.

FIGS. 3a and 3b show a first possible embodiment for a guiding means 11.2 with a variable cross-section. The guiding means 11.2 is designed as an elastic cylinder, for example made of an elastomer, and has a first threaded bore 12.1 at a first end E.1 and a second threaded bore 12.2 at a second end E.2. Screws 13.1, 13.2 engage in the threaded bores 12.1, 12.2 and are respectively counter-mounted on counter bearings 14.1, 14.2 connected to the cyclone separator 1. The guiding means 11.2 can then be stretched or compressed between the counter bearings 14.1, 14.2 by turning the screws 13.1, 13.2. FIG. 3b shows a first stretched contour 15.1, which results when the guiding means 11.2 is stretched, and in which the cross-section is constricted, particularly in the axial direction A in the center of the guiding means 11.2, and thus reduced. FIG. 3b, moreover, shows a first compressed contour 15.2, which results when the guiding means 11.2 is compressed, and in which the cross-section is expanded, in particular in axial direction A in the center of the guiding means 11.2, and is thus enlarged.

FIGS. 4a and 4b show a guiding means 11.3 that largely corresponds to the guiding means 11.2, wherein repetitive descriptions are dispensed with. The guiding means 11.3 is formed from a first section 16.1, a second section 16.2 and a third section 16.3, wherein the sections 16.1 and 16.3 have a different, namely lower, modulus of elasticity than the section 16.2. In this way, as shown in FIG. 4b, when the guiding means 11.3 is compressed or stretched by means of the screws 13.1, 13.2, a second stretched contour 17.1 or a second compressed contour 17.2 is achieved which have a constant cross-section over the axial extension of the guiding means 11.3, i.e. a uniform constriction or expansion.

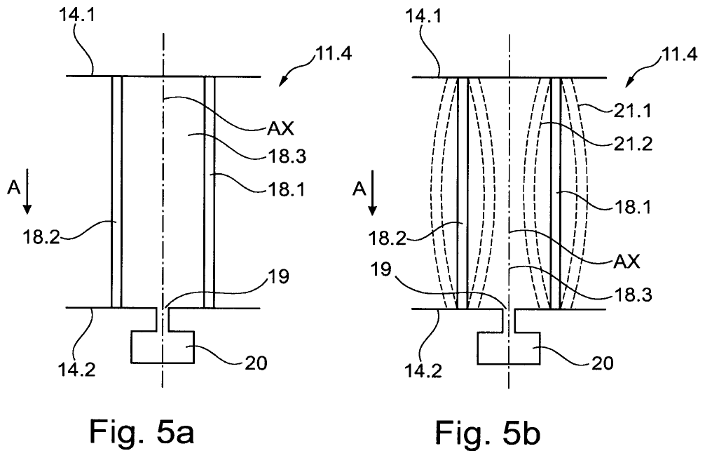

FIGS. 5a and 5b show a yet further embodiment of a guiding means 11.4, wherein the guiding means 11.4 is designed as a guide tube comprising tube walls 18.1, 18.2 extending between the counter bearings 14.1, 14.2. Here, the counter bearing 14.2 comprises an opening 19, via which an inner space 18.3 of the guiding means 11.4 is connected to a means 20 for supplying or discharging air or other gas to or from the inner space 18.3. The guiding means 14.3 can thus be inflated or evacuated, resulting in either an inflated contour 21.1 or an evacuated contour 21.2 of the tube walls 18.1, 18.2, as shown in FIG. 5b.

### LIST OF REFERENCE SYMBOLS

1 cyclone separator
2 circumferential wall
2.1 first wall section
2.2 second wall section
3 process space
4 inlet port
5 covering
6 outlet port
7 immersion tube
8 solids outlet
9 orifice
10 trajectory
10.1 first area of the trajectory
10.2 deflection point
10.3 second area of the trajectory
11.1 guiding means
11.2 guiding means
11.3 guiding means
11.4 guiding means
12.1 first threaded bore
12.2 second threaded bore
13.1 first screw
13.2 second screw
14.1 first counter bearing
14.2 second counter bearing
15.1 first stretched contour
15.2 first compressed contour
16.1 first section
16.2 second section
16.3 third section
17.1 second stretched contour
17.2 second compressed contour
18.1 first tube wall
18.2 second tube wall
18.3 inner space
19 opening
20 means for supplying or discharging air
21.1 inflated contour
21.2 evacuated contour
AX axis
A axial direction
E.1 first end of the circumferential wall
E.2 second end of the circumferential wall
U circumferential direction
R radial direction

1. A cyclone separator (1) for separating solids and/or liquids from a process stream, comprising:
a process space (3) which is round in cross-section and is formed by at least one peripheral wall (2) and a covering (5);
an inlet port (4) penetrating the circumferential wall (2) for introducing the process stream into the process space (3) in the circumferential direction (U) of the process space (3);
an outlet port (6) penetrating the covering (5) for leading the process stream out of the process space (3) in the axial direction (A) of the process space (3);
an immersion tube (7) extending from the outlet port (6) in the axial direction (A) into the process space (3); and
a guiding means (11.1, 11.2, 11.3, 11.4) extending in the center of the process space (3) in the axial direction (A) and engaging in the immersion tube (7);
wherein the guiding means (11.1, 11.2, 11.3, 11.4) is formed variable in cross-section over at least part of its axial extension.

2. A cyclone separator (1) according to claim 1, wherein the guiding means (11.1, 11.2, 11.3, 11.4) is formed as a guide tube.

3. A cyclone separator (1) according to claim 2, wherein the guide tube is formed to be elastic and an inner space (18.3) of the guide tube is formed variable in volume in order to change the cross-section of the guide tube.

4. A cyclone separator (1) according to claim 2, wherein a tube wall (18.1, 18.2) of the guide tube is formed in a spiral shape.

5. A cyclone separator (1) according to preceding clams claim 1, wherein the guiding means (11.1, 11.2, 11.3, 11.4) is formed elastic and the cyclone separator (1) comprises means for compressing and/or stretching the guiding means (11.1, 11.2, 11.3, 11.4) in order to change the cross-section of the guiding means (11.1, 11.2, 11.3, 11.4).

6. A cyclone separator (1) according to claim 5, wherein the guiding means (11.1, 11.2, 11.3, 11.4) has at least two sections (16.1, 16.2, 16.3) along its axial extension, and wherein at least two sections (16.1, 16.2, 16.3) have different moduli of elasticity from one another.

7. A cyclone separator (1) according to claim 1, wherein the guiding means (11.1, 11.2, 11.3, 11.4) comprises a plurality of sections (16.1, 16.2, 16.3) along its axial extension and at least two sections (16.1, 16.2, 16.3) are formed to be displaceable relative to one another in the axial direction (A) in order to change the cross-section of the guiding means (11.1, 11.2, 11.3, 11.4).

8. A cyclone separator (1) according to claim 1, comprising means for imparting an oscillation to the guiding means (11.1, 11.2, 11.3, 11.4) for changing the cross-section of the guiding means (11.1, 11.2, 11.3, 11.4).

9. A cyclone separator (1) according to claim 1, wherein the immersion tube (7) is formed variable in its cross-section or comprises an orifice (9) with a variable clear cross-section.

10. A cyclone separator (1) according to claim 1, wherein the guiding means (11.1, 11.2, 11.3, 11.4) is made of a plastic, in particular of an elastomer or a thermoplastic.

11. A cyclone separator (1) according to claim 1, wherein the circumferential wall (2) is formed conical over at least part of its axial extension.

12. A cyclone separator (1) according to claim 1, wherein the inlet port (4) has a slot-shaped extension in the axial direction (A) of the process space (3).

13. A cyclone separator (1) according to claim 1, comprising a solids outlet (8) arranged at one end (E.2) of the process space for discharging solids from the process space (3).

14. A method for operating the cyclone separator (1) of claim 1, wherein the cross-section of the guiding means (11.1, 11.2, 11.3, 11.4) is varied at least in a part of the axial extension of the guiding means (11.1, 11.2, 11.3, 11.4) as a function of a mass flow, a flow velocity, a solids load or a liquid load of the process stream.

15. A cyclone separator system, comprising the cyclone separator (1) of claim 1 and at least one sensor for detecting a mass flow, a flow velocity, a solids load or a liquid load of the process stream.
